(19) United States
(12) Patent Application Publication
(10) Pub. No.: US 2005/0078946 A1
(43) Pub. Date: Apr. 14, 2005

(54) Recording media assigned to user

(76) Inventor: Gerald Janisch, Wilhelmsburg (AT)

Correspondence Address: PHILIPS INTELLECTUAL PROPERTY & STANDARDS, P.O. BOX 3001, BRIARCLIFF MANOR, NY, 10510, US

(21) Appl. No.: 10/504,133

(22) PCT Filed: Feb. 3, 2003
(86) PCT No.: PCT/IB03/00372

(30) Foreign Application Priority Data
Feb. 15, 2002 (EP) 021001391

(51) Int. Cl. H04N 5/91

(52) U.S. Cl. 386/95

(57) ABSTRACT

A recording device (1) for recording recording data (AD) on one of possibly several recording media (16, 17, 18, 19) is provided with receiving means (7) for receiving receive data (ED) and user identifying information (BKI), identifying a user of the recording device (1), and with processing means (8) for processing the received receive data (ED) and for outputting recording data (AD), and with recording means (9) for recording the recording data (AD) on a recording medium (18), the recorded recording data (AD) being assigned to the user identified by the received user identifying information (BKI); also at least one recording medium (16, 17, 18, 19) may be assigned to each receivable item of user identifying information (BKI) and the recording means (9) are designed to record the recording data (AD) on the recording medium (16, 17, 18, 19) identified by the received user identifying information (BKI).

The invention relates to a recording device for recording recording data on one of possibly several recording media, having receiving means for receiving receive data and user identifying information identifying a user of the recording device and having processing means for processing the received receive data and for outputting the recording data and having recording means for recording the recording data on a recording medium, the recorded recording data being assigned to the user identified by the received user identifying information.

The invention also relates to a recording method for recording recording data on one of possibly several recording media, wherein the following steps are executed:
reception of receive data and reception of user identifying information identifying a user of the recording device and processing of the received receive data and outputting of the recording data and recording of the recording data on a recording medium, the recorded recording data being assigned to the user identified by the received user identifying information.

Such a recording device and such a recording method are known from document GB 3 346 251 A and take the form of a hard disk recorder. The known hard disk recorder is designed to record receive data containing television programs on a recording medium consisting of a hard disk. A user of the hard disk recorder may register as a new user of the hard disk recorder by filling in a “New User Menu”, whereupon user identifying information is assigned to the user.

If the user wishes to record a television program on the hard disk for subsequent playback of said television program, he/she first has to input his/her user identifying information. The recording data recorded during the recording of the television program are then assigned to the user identifying information of said user when recorded on the hard disk.

If the user wishes to play back a previously recorded television program, he/she has to input his/her user identifying information, whereupon all the television programs recorded for this user on the hard disk are listed for the user in a “play list”. Once the user has selected one of the listed television programs, the hard disk recorder begins to play back the playback data assigned to the user on the hard disk for this selected television program.

If the user wishes to pass on one or more television programs recorded for him/her to a friend, for example, the known hard disk recorder has a copy mode which allows the appropriate playback data for these television programs to be copied onto a portable recording medium.

In the case of the known recording device and the known recording method, it has proven disadvantageous that only recording data or playback data for one or more recorded television programs can be assigned to a user. The user does not have any possibility of influencing the physical location of the recording on the recording medium. In this way, in addition to other disadvantages, the hard disk recorder also requires the above-described copy mode in order to copy particular recordings onto a particular recording medium.

The object of the invention is to provide a recording device of the type indicated in the first paragraph and a recording method of the type indicated in the second paragraph, in which the above-mentioned disadvantages are avoided. To achieve the object indicated above in relation to such a recording device, at least one recording medium may be assigned to each receivable item of user identifying information and the recording means are designed to record the recording data on the recording medium identified by the received user identifying information.

To achieve the object indicated above in relation to such a recording method, at least one recording medium is assigned to each item of received user identifying information and the recording data are recorded on the recording medium identified by the received user identifying information.

The features according to the invention ensure that one or more physical recording media may be assigned to each user. As soon as the user has identified him/herself by input of his/her user identifying information, all the recording data to be recorded for this user are recorded on this recording medium assigned to the user. Such structuring is especially advantageous when the recording medium is a portable recording medium which may be removed from the recording device. In this case, the user may carry with him/her all the recording data recorded for him/her by removing his/her recording medium or media.

It is likewise possible for the user identifying information identifying the user to be recorded on the recording medium. By inserting such a recording medium into the recording device, the user identifies him/herself with respect to the recording device, so that the input of the user identifying information by the user is advantageously dispensed with.

According to the steps heb of claim 2, the advantage is achieved that a plurality of recording media may be introduced into the recording device and that the recording medium changing means position the recording medium identified by the input user identifying information towards the recording means before recording begins.

In this way, for example, a DVD-RW may be assigned as a recording medium to each family member and if a family member, for example, the son of the family, initiates the recording of a television program using the recording device, the DVD-RW assigned to the son is automatically used for recording the television program. Each family member, and hence also the son, may remove the DVD-RW assigned to him/her from the recording device at any time and thus take his/her recordings round to a friend, for example. Recordings made for the son in a recording device likewise according to the invention at the son's friend's house are then likewise automatically recorded on the son's DVD-RW and can in turn easily be taken home.

In addition, the advantage is obtained that the father of the family, for example, may be sure, by removing the DVD-RW assigned to him, that no television program recorded by him is accessible to the son, for example. In this way, it is possible to dispense in simple manner with the input of passwords and number codes for protecting recorded television programs from undesired access, as is necessary with known recording devices.

According to the steps of claim 3, the advantage is achieved that it is not the recording medium itself but rather a recording medium holder of the recording medium changing means which is assigned to user identifying information of a user. Each recording medium inserted into this recording medium holder is thus assigned to the user. This has the advantage that the user can always insert a recording medium with free recording capacity into his/her recording medium holder without having to perform any assignment procedures. The recording device automatically uses the recording medium contained in the recording medium holder assigned to the user for recordings for this user.

According to the steps of claim 4, the advantage is achieved that two or even more recording media may be assigned to the user, depending on the recording capacity required by a user.

According to the steps of claim 5, the advantage is achieved that one recording medium may also be assigned to two or more users. Thus, for example, one recording medium could be assigned to the children of a family, since both may record and playback television films suitable for similar ages.

The invention will be further described with reference to an embodiment shown in the drawings, to which, however, the invention is not restricted.

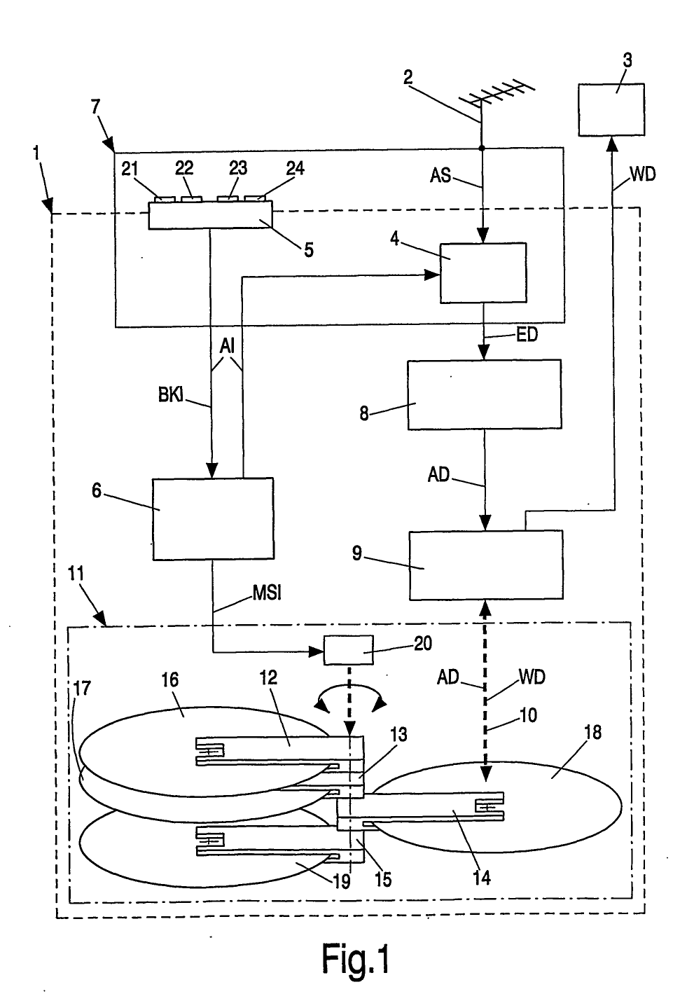

FIG. 1 shows a DVD recorder with a DVD changer, in which recording medium holders can be assigned to the users of the DVD recorder.

FIG. 1 shows a DVD recorder 1, to which an aerial 2 and a television set 3 are connected. An aerial signal AS may be output by the aerial 2 to a tuner 4 of the DVD recorder 1. Receive data ED from a plurality of television broadcasters, such as for example CNN, are contained in the aerial signal AS and the tuner 4 is designed to select receive data ED of one of the television broadcasters, as is generally known.

A user of the DVD recorder 1 may select the desired television broadcaster by means of a keypad 5 on the DVD recorder 1, whereupon selection information AI is output to controller means 6 of the DVD recorder 1 and thence to the tuner 4. The tuner 4 and the keypad 5 form receiving means 7 for receiving receive data ED. In addition, user identifying information BKI, identifying the user, may be input by way of the keypad 5; this will be described in more detail below.

Receive data ED received by the tuner 4 may be output to processing means 8 of the DVD recorder 1. The processing means 8 are designed to process the receive data ED and to output recording data AD recordable onto a recording medium in the form of a DVD-RW (Digital Versatile Disk Read Write), as known from standard DVD recorders.

Recording means 9 of the DVD recorder 1 are designed to record, via an active connection 10, the recording data AD output thereto onto a DVD-RW applied to the recording means 9. The recording means 9 contain buffer memory means and further known means for recording the recording data AD onto a DVD-RW, for which reason they will not be described in any more detail.

The DVD recorder 1 contains a DVD changer 11 with a first recording medium holder 12, a second recording medium holder 13, a third recording medium holder 14 and a fourth recording medium holder 15. A first DVD-RW 16, a second DVD-RW 17, a third DVD-RW 18 and a fourth DVD-RW 19 may be introduced or inserted into the four recording medium holders 12, 13, 14 and 15. Motor control information MSI may be output by the controller means 6, consisting of a microprocessor and an EEPROM, to a control stage 20 of the DVD changer 11 in order to swivel each time one of the recording medium holders 12, 13, 14 or 15 through 180 degrees and to apply the DVD-RW 16, 17, 18 or 19 contained in this swiveled recording medium holder to the recording means 9. FIG. 1 shows the third DVD-RW 18 contained in the third recording medium holder 14 as having been applied to the recording means 9.

More details of operation and the advantages of the DVD recorder 1 are explained more fully below with reference to an example of application. According to the example of application, it is assumed that a family (father, mother, son and daughter) have bought the DVD recorder 1 and have already gone through the usual installation procedures. The DVD recorder 1 then enquires which users will use the DVD recorder 1, in order to assign to each user user identifying information BKI for subsequently identifying the user. A first item of user identifying information BKI1 is assigned to the father, which he may input by actuating the key 21. A second item of user identifying information BKI2 and the key 22 are assigned to the mother, a third item of user identifying information BKI3 and the key 23 are assigned to the son and a fourth item of user identifying information BKI4 and the key 24 are assigned to the daughter.

The controller means 6 are designed so as to assign each of these items of user identifying information BKI1, BKI2, BKI3 and BKI4 to at least one recording medium holder 12, 13, 14 or 15 and thereby to at least one recording medium, i.e. one of the DVD-RWs 16, 17, 18 or 19. To this end, the user is asked to indicate what recording capacities (one to four times the recording capacity of one DVD-RW) are to be available to which users.

According to the present example, the DVD recorder 1 is programmed by the family in such a way that the first recording medium holder 12 is assigned to the first item of user identifying information BKI1 belonging to the father, the second and third recording medium holders 13 and 14 to the second item of user identifying information BKI2 belonging to the mother and the fourth recording medium holder 15 to the third item of user identifying information BKI3 belonging to the son and the fourth item of user identifying information BKI4 belonging to the daughter.

Direct assignment of one or more DVD-RWs to one or more users is thus advantageously achieved. The father may now advantageously record television programs within the bounds of the recording capacity on the first DVD-RW 16, the mother within the bounds of the recording capacities on the second DVD-RW 17 and the third DVD-RW 18 and the children within the bounds of the recording capacity on the fourth DVD-RW 19. Further advantages of this direct assignment are as follows.

Let it be assumed that the father regularly records the television programs in the science series “Universum”. For this purpose, when programming he actuates the key 21 assigned to him, in addition to making the usual program entries (date, broadcaster, time, . . . ), so that the first item of user identifying information BKI1 is output by the keypad 5 to the controller means 6. Immediately before recording of the television program “Universum” starts, the controller means 6 output the motor control information MSI to the control stage 20 in order to swivel the first recording medium holder 12, assigned to the first item of user identifying information BKI1, through 180 degrees and apply it to the recording means 9. The television program “Universum” is thus recorded for the father on the first DVD-RW 16 assigned to the father.

In this way, the advantage is achieved that all the father's television program recordings are recorded on the first DVD-RW 16. The father may thus remove all his recordings from the DVD recorder 1 by simply removing the first DVD-RW 16. He may then keep the first DVD-RW 16 in a safe place, thereby preventing access to his recordings. In addition, the father may take his first DVD-RW 16 to a friend who has an arbitrary standard DVD recorder and there playback all his recordings or also record further television programs.

A particular advantage is that the father may insert a further DVD-RW into the first recording medium holder 12 assigned to him and effect further recordings on this further DVD-RW. This advantage is achieved by assigning a recording medium holder to a user and not a recording medium.

If, on the other hand, the daughter wishes to record a television program, she actuates the fourth key 24, whereupon the fourth item of user identifying information BKI4 is output to the controller means 6. The recording data of the television program that the daughter wants, as indeed the television programs that the son wants, are recorded on the fourth DVD-RW 19 contained in the fourth recording medium holder 15.

By assigning two or more users to a single recording medium holder or to a single recording medium, the advantage is achieved that these users can share dynamically the recording capacity of one recording medium.

The recording means 9 additionally form playback means for playing back playback data WD which have been recorded as recording data AD on the DVD-RW applied to the recording means 9. The played-back playback data WID may be fed to the television set 3 for playback of the recorded television program.

Prior to playback of a recorded television program, the respective user is required to input his/her user identifying information BKI, whereupon the television programs recorded on his/her DVD-RW(s) are displayed to the user for him/her to select. The DVD-RW assigned to the user is then applied to the recording means 9 by the DVD changer 11 and playback of the playback data WD of the television program selected by the user may start.

The DVD recorder 1 is additionally so designed that, if the son actuates the key 23, only the television programs recorded for him on the fourth DVD-RW 19 and not the television programs recorded for the daughter on the fourth DVD-RW 19 are displayed. The fourth DVD-RW 19 assigned to both the daughter and the son is, therefore, advantageously subdivided by the controller means 6 into two logical units. In this way, a substantially larger number of users may be assigned to a relatively small number of recording media. In each of these cases, however, users are assigned unambiguously to a particular recording medium, thereby achieving the above-described advantages.

According to a second embodiment, not illustrated in FIG. 1, direct assignment of an item of user identifying information BKI to a recording medium may also be effected by a recording device according to the invention. In this case, when the user identifying information BKI is assigned to the recording medium during the installation procedure, an item of user identifying information BKI input by the user may be output by the controller means to the recording means and recorded thereby on the recording medium to be assigned.

In an inventory procedure, this recording device according to the second embodiment may swivel all the recording medium holders towards the playback means in succession and read out the user identifying information BKI of the recording media contained in the recording medium holders and store it in the controller means. In this way, the recording medium to be used for each user is identified and may be used for subsequent recording and playback procedures.

If the user identifying information takes the form of a character code to be input with the keypad of the recording device, the assignment according to the invention of the recording medium to the user is effected for every recording device, not just the user's own. In this case, the father could take his recording medium round to a friend and insert it into the friend's recording device according to the invention. This recording device would then perform the inventory procedure and, once the father had input the character code constituting his user identifying information BKI, the friend's recording device would also record onto and playback from the father's recording medium.

It may be mentioned that a plurality of different, optionally portable recording media which could be used in a recording device according to the invention are known to the person skilled in the art. For example, the recording media could be the following: SACD (Super Audio Compact Disk), CD-R, DVD+RW, DVD-RW, VCD (Video-CD), DVD+R, DVD-R, DVD-RAM, hard disk, Linear Tape Open magnetic tape.

It may be mentioned that a plurality of different recording medium changer means are known and that the invention is in no way limited to the design according to FIG. 1.

1. A recording device (1) for recording recording data (AD) on one of possibly several recording media (16, 17, 18, 19), having
receiving means (7) for receiving receive data (ED) and user identifying information SKI) identifying a user of the recording device (1) and having
processing means (8) for processing the received receive data (ED) and outputting the recording data (AD), and having
recording means (9) for recording the recording data (AD) on a recording medium (16, 17, 18, 19), the recorded recording data (AD) being assigned to the user identified by the received user identifying information (BKI),
characterized in that at least one recording medium (16, 17, 18, 19) may be assigned to each receivable item of user identifying information (BK) and in that the recording means (9) are designed to record the recording data (AD) on the recording medium (16, 17, 18, 19) identified by the received user identifying information (BKI).

2. A recording device (1) as claimed in claim 1, characterized in that recording medium changing means (11) are provided with at least two recording medium holders (12, 13, 14, 15), into each of said recording medium holders (12, 13, 14, 15) there may be introduced a recording medium (16, 17, 18, 19) identified by user identifying information (BKI), the recording medium changing means (11) being designed to change the position of the recording medium holder (12, 13, 14, 15) of the recording medium (16, 17, 18, 19) identified by the received user identifying information (BKI) in order to allow recording of the recording data (AD) on this recording medium (16, 17, 18, 19).

3. A recording device (1) as claimed in claim 1, characterized in that recording medium changing means (11) are provided with at least two recording medium holders (12, 13, 14, 15) into each of said recording medium holders (12, 13, 14, 15), each identifiable by user identifying information (BKI), a recording medium (16, 17, 18, 19) may be introduced, the recording medium changing means (11) being designed to change the position of the recording medium holder (16, 17, 18, 19) identified by the received user identifying information (SKI) in order to allow recording of the recording data (AD) on the recording medium (16, 17, 18, 19) accommodated in this recording medium holder (12, 13, 14, 15).

4. A recording device (1) as claimed in claim 1, characterized in that two or more recording media (16, 17, 18, 19) may be assigned to each receivable item of user identifying information (BKI).

5. A recording device (1) as claimed in claim 1I characterized in that one recording medium (16, 17, 18, 19) may also be assigned to two or more items of user identifying information (SKI).

6. A recording device (1) as claimed in claim 1, characterized in that the playback means (9) are designed to play back playback data (WD) from a recording medium (16, 17, 18, 19) identified by the received user identifying information (BKI).

7. A recording device (1) as claimed in claim 1, characterized in that the recording medium (16, 17, 18, 19) is optically readable.

8. A recording device (1) as claimed in claim 1, characterized in that the recording medium (16, 17, 18, 19) takes the form of a DVD-RW.

9. A recording method for recording recording data (AD) on one of possibly several recording media (16, 17, 18, 19), wherein the following steps are executed:
reception of receive data (ED) and reception of user identifying information (BKI) identifying a user of a recording device (1) executing the recording method and
processing of the received receive data (ED) and outputting of the recording data (AD) and
recording of the recording data (AD) on a recording medium (16, 17, 18, 19), the recorded recording data (AD) being assigned to the user identified by the received user identifying information (YKI),
characterized in that at least one recording medium (16, 17, 18, 19) is assigned to each item of received user identifying information (BKI) and in that the recording data (AD) are recorded on the recording medium (16, 17, 18, 19) identified by the received user identifying information (BKI).

10. A recording method as claimed in claim 9, characterized in that, prior to recording the recording data (AD), the recording medium (16, 17, 18, 19) identified by the received user identifying information (SKI) is selected from at least two recording media (16, 17, 18, 19) and positioned for recording.
